(19) United States
(12) Patent Application Publication
(10) Pub. No.: US 2009/0326875 A1
(43) Pub. Date: Dec. 31, 2009

(54) DEVICE AND METHOD FOR CLASSIFYING/DISPLAYING DIFFERENT DESIGN SHAPE HAVING SIMILAR CHARACTERISTICS

(75) Inventors: Hitoshi Yanami, Kawasaki (JP); Hirokazu Anai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/421,418

(22) Filed: Apr. 9, 2009

(30) Foreign Application Priority Data
Jun. 27, 2008 (JP) 2008-168318

(51) Int. Cl. G06F 17/50; G06N 5/02; G06F 17/10

(52) U.S. Cl. 703/1; 706/54; 703/2

(57) ABSTRACT

A system displays an area which a desired objection function value of a plurality of objective functions as a possible area in objective space corresponding to the objective function on the basis of each of the plurality of objective function value sets calculated for a plurality of design parameter sample sets; calculates a design parameter set in design space corresponding to the neighborhood area of a position in the objective space based on the position specification in relation to position specification by a user in the possible area of the objective space; and calculates and displays a representative design shape corresponding to the calculated design parameter set.

### CROSS-REFERENCE TO RELATED APPLICATION

This application is based upon and claims the benefit of priority of the prior Japanese Patent No. 2008-168318, filed on Jun. 27, 2008, the entire contents of which are incorporated herein by reference.

### FIELD

The embodiments discussed herein are related to a multi-objective optimal design support technology used in designing.

### BACKGROUND

Along with the high-density/high-capacity of hard disks, a distance between a magnetic disk and a header has decreased more and more. Thus, slider design to reduce an alteration of flying height due to an altitude difference and a disk radius position is needed.

In FIG. 1, a slider 2101 is mounted on the tip bottom of an actuator 2102 which moves on a magnetic disk of a hard disk and the position of a header is calculated on the basis of the shape of the slider 2101.

In determining the optimal shape of the slider 2101, efficient calculation, so-called multi-objective optimization, for minimizing the function related to flying height (2103 in FIG. 1), roll (2104) and pitch (2105) which affect the position of a header is needed.

Conventionally, instead of directly handling multi-objective optimization, single-objective optimization in which the linear sum f of terms obtained by multiplying each objective function f_i by weight m_i is calculated and its minimum value is calculated is performed as follows.

f=m_{—}1*f_{—}1+ . . . +m_{—}t*f_{—}t (1)

Then, after a designer determines a shape for a base, the swing ranges of parameters p, q, r and the like, for determining a slider shape S illustrated in FIG. 2 are set by a program, a function value f is calculated while changing their values little by little such that a slider shape in which the value f are minimized is calculated.

The value f depends on a weight vector {m_i}. In actual calculation, the minimum value of f corresponding to each changed value is calculated with the parameter {m_i} changing, and a slider shape is determined comprehensively in light of the balance between its minimum value and {m_i}.

In such a multi-objective optimization process performed on the basis of the above-described method, the number of optimal solutions is not always one.

For example, a case where an objective function value 1 of “reducing weight” and an objective function value 2 of “suppressing costs” are optimized in designing a certain product is considered. In this case, the objective function values 1 and 2 may take various coordinate values on a two-dimensional coordinate as illustrated in FIG. 3 depending on how to give design parameters.

Both the objective function values 1 and 2 are required to have small values (for light weight and low cost). Therefore, points on and around a line 2303 connecting calculated points 2301-1, 2301-2, 2301-3, 2301-4 and 2301-5 illustrated in FIG. 3 can be a group of optimal solutions. These are called Pareto optimal solutions. Of these calculated points, points 2301-1 and 2301-5 correspond to a model in whose weight is reduced but whose cost is not reduced and a model whose cost is reduced but whose weight is not reduced, respectively. However, calculated points 2302-1 and 2302-2 cannot be optimal solutions since their weight or cost can be still reduced. These are called inferior solutions.

In the multi-objective optimization process, it is very important to appropriately catch Pareto solutions. For that purpose, it is very important to appropriately visualize Pareto optimal solutions in a desired objective function.

In the above optimization technology of a single-objective function f, time-taking flying height computation must be repeated. Especially, when probing the fine parts of a slider shape, the number of input parameters (corresponding to p, q, r and the like in FIG. 2) becomes about 20 and ten thousands or more calculations for flying height are needed. Therefore, it takes very much time to optimize.

Furthermore, in this method, the minimum value of f (and each input parameter value at that time) depends on how to determine weight vectors (m_1, . . . , m_t). In actual calculation, it is often desired that f is optimized against various sets of weight vectors. However, in the above-described prior art, since it is necessary to reset optimization calculation accompanying high-cost flying height computation from the beginning when a set of weight vectors are modified, the number of viable types of the set of weight vectors is limited.

Furthermore, in the minimization of a function value f, since only one point can be obtained on a Pareto curved surface each time, it is difficult to predict the optimal relationship among objective functions. Therefore, such information (relationship) cannot be fed back to design.

When one point is obtained on a Pareto curved surface as an optimal solution, one set of design parameters is determined with the solution and one design shape is obtained. However, a designer is not always satisfied with the design shape. When not satisfied with it, conventionally, as illustrated in FIG. 4, firstly the designer works out a base shape (block S2401) performs optimization by a program (block S2402). When one solution is outputted by the optimization program (block S2403) the designer determines whether a shape outputted in relation to the solution is satisfying (block S2404). If it is not satisfying, the designer repeatedly has to devise a new base shape again (block S2401) and perform optimization (blocks S2402-S2404).

Conventionally, the process itself of a multi-objective optimization takes very much time. Therefore, even when the above-described operation is repeated, it is difficult even to display an appropriate Pareto optimal solution. Thus, there is no such design support method in which optimization is efficiently repeated while determining design shapes obtained on the basis of the optimal solution.

Furthermore, conventionally since a designer depends on its own experiences and intuition in determining a base shape, how an optimal result is reflected in a subsequent base shape design is left to the designer. Therefore, the designer is prejudiced by an optimal shape outputted by a program and is often prevented from working out a new base shape. As a result, it is very difficult to find a different optimal solution whose base shape greatly differs and design freedom is limited.

As a technical reference, there is Japanese Laid-open Patent Publication No. H7-44611.

### SUMMARY

The object of embodiments of the present invention is to provide a designer with a plurality of efficient design shapes close to optimal solutions and hints on new base shapes by realizing visualization (display of a Pareto boundary, etc.) on the basis of objective functions in a short time and the analysis of a group of design parameters mapped near its optimal solution while displaying Pareto optimal solutions appropriately on the basis of the visualization.

The aspect of the present technology presumes supporting the determination of an optimal design parameter set by inputting a plurality of sets (combinations of respective design parameter values) of design parameters (input parameters), calculating a plurality of objective functions on the basis of a prescribed calculation and performing a multi-objective optimization process of the plurality of objective functions. The design parameters are, for example, parameters for determining the shape of the slider unit of a hard disk magnetic storage device.

The first aspect has the following configuration.

An objective space display unit displays an area which the value of some (arbitrarily-selected) of the plurality of objective functions can take as a possible area in objective space corresponding to the object function on the basis of the plurality of objective function set calculated for each of a plurality of design parameter sample sets.

An objective space-corresponding design space calculation unit calculates a design parameter set in design space corresponding to the neighborhood area of a position in the objective space based on the position specification in relation to position specification by a user in the possible area of the objective space corresponding to a desired objective function displayed by the objective space display unit. This unit may include, for example, a function value calculation unit for calculating each mapped point in objective space corresponding to each design parameter set constituting a plurality of grid points for dividing design space and an inverse mapper for calculating a design parameter set constituting a grid point corresponding to a mapped point included in the neighborhood area of a position in objective space based on the position specification by a user, of respective mapped points as a design parameter set in design space corresponding to the neighborhood area of a position in objective space based on the position specification.

A representative shape display unit calculates and displays a representative design shape corresponding to the design parameter set calculated by the objective space-corresponding design space calculation unit. This may further include, for example, a design parameter classification unit for classifying the design parameter set calculated by the objective space-corresponding design space calculation unit into a plurality of groups. The representative shape display unit can calculate and display a representative design shape corresponding to the design parameter set representing each group classified by the design parameter classification unit.

The second aspect has the following configuration.

A sample set objective function calculation unit calculates a plurality of objective function sets of a prescribed number of design parameter sample set.

An objective function approximation unit mathematically approximates a plurality of objective functions on the basis of a prescribed number of design parameter sample sets and a plurality of objective function sets calculated in relation to the design parameter sample sets.

An inter-objective function logical expression calculation unit calculates a logical expression for expressing a logical relationship among arbitrary objective functions of the plurality of mathematically approximated objective functions as an inter-objective function logical expression.

An objective space display unit displays an area which an arbitrary objective function value can take as a possible area in objective space corresponding to an arbitrary objective function according to the inter-objective function logical expression.

An objective space-corresponding design space calculation unit and a representative shape display unit are the same as those of the first aspect.

The object and advantages of the invention will be realized and attained by means of the element and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 explains a slider of a hard disk.

FIG. 2 explains parameters for a slider shape.

FIG. 3 explains a multi-objective optimization.

FIG. 4 is an operational flowchart illustrating the conventional multi-objective optimizing operation.

FIG. 5 is the functional block configuration of this preferred embodiment.

FIG. 6 is an operational flowchart illustrating the processes of an actual flying height computation execution unit 101 and an objective function polynomial approximation unit 102.

FIG. 7 is an operational flowchart illustrating the processes of an objective function selection unit 103, an inter-objective function logical expression calculation unit 104 and a possible area display unit 105.

FIG. 8 is an operational flowchart illustrating the processes of a function value calculation unit 106 and an inverse mapper 107.

FIG. 9 is an operational flowchart illustrating the process of an inverse mapping classification/calculation unit 108.

FIG. 10 illustrates an input parameter sample set 110 and each objective function value example corresponding to the input parameter sample set.

FIG. 11 illustrates a possible area display example (No. 1).

FIG. 12 illustrates a possible area display example (No. 2).

FIG. 13A illustrates a possible area display example obtained using the input parameter sample set 110 corresponding to an actual slider shape.

FIG. 13B illustrates a possible area display example in the case where the boundary of a logical expression is also displayed.

FIG. 14 explains a merit of displaying a possible area on the mathematical process base.

FIG. 15 explains the meshing of design space.

FIGS. 16A and 16B explain how to take the neighborhood point of point P1 in objective space.

FIG. 17 explains calculation for an inverse mapping (No. 1).

FIG. 18 explains the operating principle of an inverse mapping classification process of the inverse mapping classification/calculation unit 108.

FIG. 19 illustrates a possible area display example and a slider shape display example corresponding to an optimal solution.

FIG. 20 explains calculation for an inverse mapping (No. 2).

FIGS. 21A through 21C illustrate inverse mapping classification examples.

FIGS. 22A through 22D illustrate representative shape display examples.

FIG. 23 illustrates an example distribution of the objective function of a representative shape.

FIG. 24 illustrates an example hardware configuration of a computer capable of realizing a system according to this preferred embodiment.

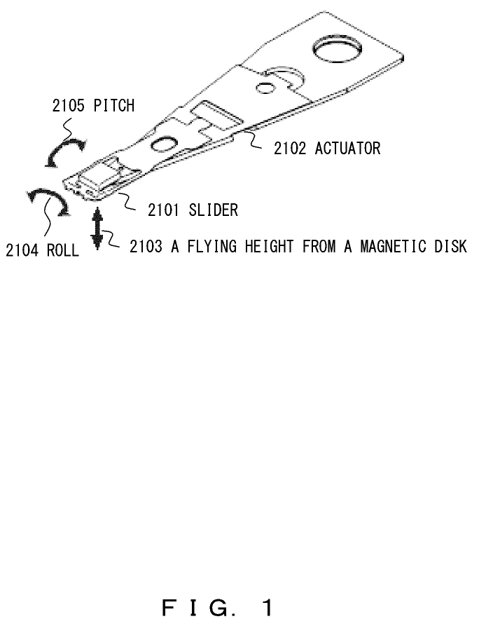

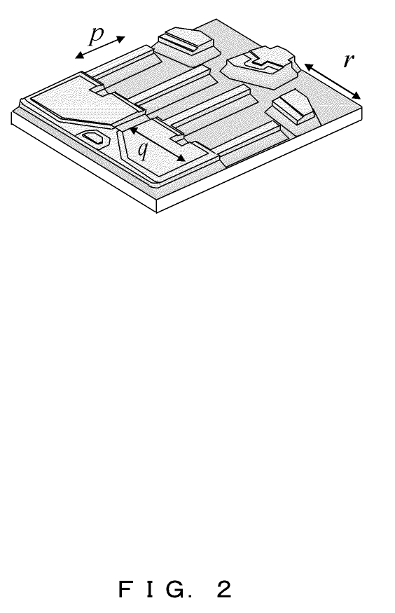

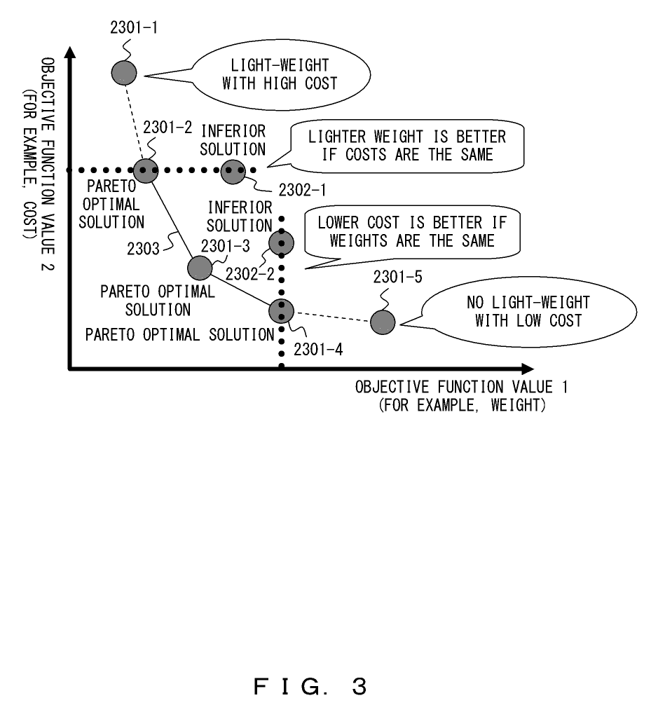

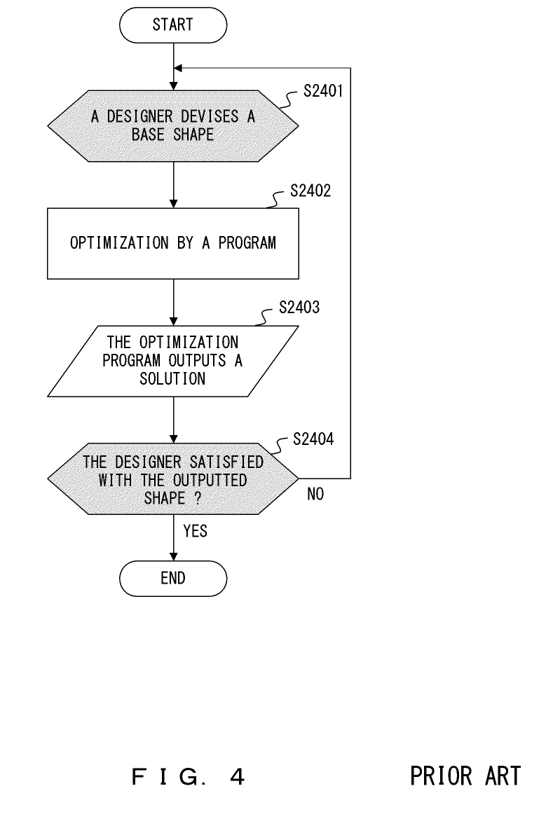

### DESCRIPTION OF EMBODIMENT

The preferred embodiments of the present invention will be explained below with reference to accompanying drawings.

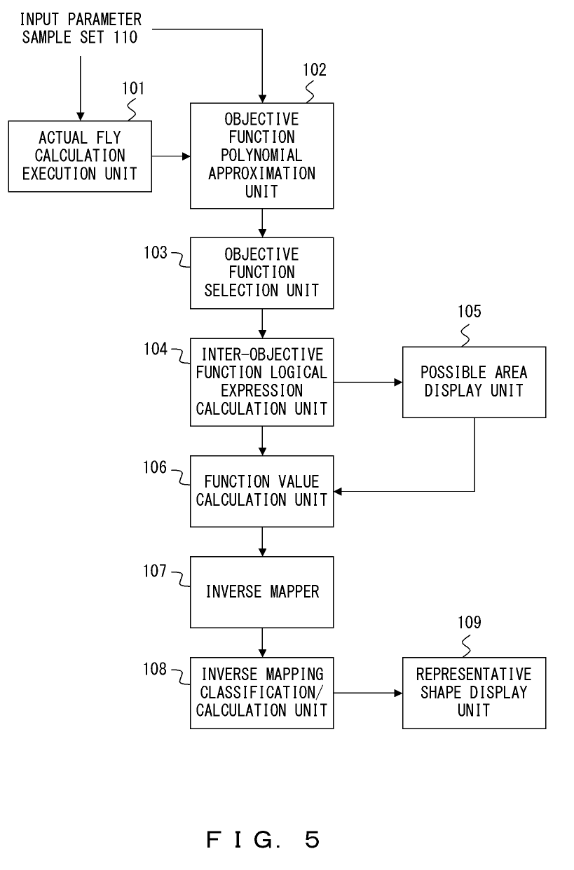

FIG. 5 is the functional block configuration of this preferred embodiment.

The actual flying height computation execution unit 101 inputs the input parameter sample sets 110 about the slider shape of a hard disk, applies the flying height computation of a slider to each set and outputs each objective function value. In this case, it is sufficient if the number of input parameter sample sets 110 is at most approximately several hundreds.

The objective function polynomial approximation unit 102 approximates each objective function about a slider shape to each objective function value of each set, calculated by the actual flying height computation execution unit 101 by a polynomial by a multi-regression expression based on multi-regression analysis or the like. Although in this preferred embodiment, an approximation example based on multi-regression analysis is used, another generally known polynomial approximation method, such as various polynomial interpolation methods, a method of increasing the degree of a polynomial and approximating or the like can be also used.

The objective function selection unit 103 enables a user to select two or three objective functions whose possible area may be displayed.

The inter-objective function logical expression calculation unit 104 calculates a logical expression among arbitrary two or three objective functions selected by the user in the objective function selection unit 103 on the basis of each objective function polynomial calculated by the actual flying height computation execution unit 101 and the restraints of each parameter value of the input parameter sample set 110 by an quantifier elimination (QE) method.

The possible area display unit 105 displays the possible area of an objective function on a computer display, which is not especially illustrated in FIG. 5, according to the logical expression among the objective functions of any two or three objective functions selected by the user in the objective function selection unit 103, calculated by the inter-objective function logical expression calculation unit 104.

The function value calculation unit 106 maps each grid point into objective space, the grid points being obtained by cutting a coordinate (design space) composed of design parameters in mesh using the two or three specified objective functions calculated by the objective function polynomial approximation unit 102 illustrated in FIG. 5. The function value calculation unit 106 thus calculates a corresponding point to the grid points.

The inverse mapper 107 set a neighborhood area [P1] around a specified point P1 in the objective space which is specified by the user in the possible area displayed by the possible area display unit 105 and calculates only a grid point in design space, corresponding to a mapped point included in the specified area [P1].

The inverse mapping classification/calculation unit 108 classifies sets of similar grid points in the design space, calculated by the inverse mapper 107 into the same group while calculating a distance (degree of approximation) between respective sets.

The representative shape display unit 109 calculates each design parameter set representing each classified group, and displays each representative shape corresponding to each design parameter set on a computer display, which is not illustrated in FIG. 5.

The operation of this preferred embodiment having the above-configuration is explained below.

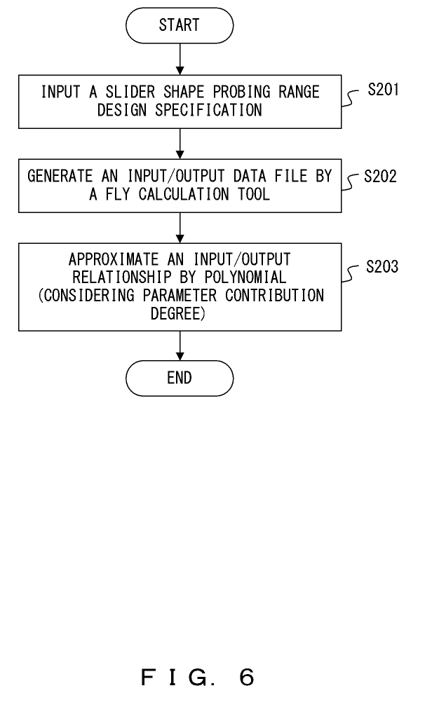

FIG. 6 is an operational flowchart illustrating the processes of the actual flying height computation execution unit 101 and the objective function polynomial approximation unit 102.

Firstly, the actual flying height computation execution unit 101 illustrated in FIG. 5 inputs approximately several hundreds of input parameter sample sets 110 as a design specification about the probing range of a slider shape (block S202 in FIG. 6), applies flying height computation for the slider to each set and outputs each objective function value (block S202 in FIG. 6).

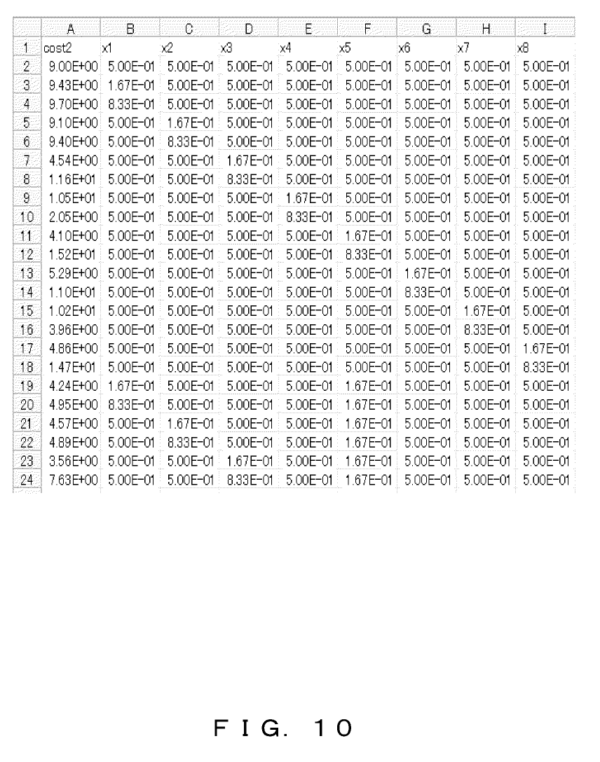

Thus, for example, a data file of input parameter sample sets 110 and their objective function values as illustrated in FIG. 10 may be generated. In FIG. 10, values in lines expressed as x1 through x8 are respective input parameter sample sets 110 and values in the column labeled “cost2” are groups of a certain objective function values.

Then, the objective function polynomial approximation unit 102 illustrated in FIG. 5 approximates each objective function about a slider shape to a data file composed of the input parameter sample sets and each calculated objective function value of each set using a polynomial by a multi-regression expression based on multi-regression analysis or the like (block S203 in FIG. 6).

As a result, an objective function polynomial exemplified below can be obtained as follows.

f1:=99.0424978610709132−6.83556672325811121*x1+14.0478279657713188*x2·18.6265540605823148*x3−28.3737252180449389*x4−2.42724827545463118*x5+36.9188200131846998*x6−46.7620704128296296*x7+1.05958887094079946*x8+6.50858043416747911*x9−11.3181110745759242*x10−6.35438297722882960*x11+4.85313298773917622*x12−11.142898807281405*x[13]+35.3305897914634315*x14−53.2729720194943113*x15; (2)

In a slider design there is a tendency that the types of input parameters increase as the work progresses. Sometimes (due to the influence of another parameter) it can be estimated that there is a parameter whose contribution to a certain objective function is low. Therefore, by incorporating a routine for eliminating a parameter whose contribution is low, using multi-regression analysis or the like, approximation by a simpler polynomial becomes possible. When a designer inputs the number of parameters used for the analysis, the objective function polynomial approximation unit 102 narrows the number of parameters up to its preset number. By this parameter reduction process, the amount of calculation may be reduced at the calculation time of a QE method, which will be described later. As a result, the polynomial of an objective function whose number of parameters is reduced, as illustrated below, can be obtained. In Expression 3, the number of parameters is reduced from 15 to 8.

f1:=100.236733508603720−0.772229409006272793*x1−20.7218054045105654*x3−5.61123555392073126*x5+27.4287250065600468*x6−52.6209219228864030*x7+2.86781289549098428*x8−1.51535612687246779*x11−51.1537286823153181*x15; (The number of variables is reduced from 15 to 8.) (3)

As explained above, in this preferred embodiment, an objective function approximated using a polynomial by multi-regression expression or the like can be obtained using at most approximately several hundreds of input parameter sample sets. In a slider design, an initial slider shape is usually provided and a designer may optimize the shape by swinging its parameters. The designer may thus approximates and obtain such a objective function with a polynomial. In optimization in such a local design change range, it is known that sufficiently effective initial optimization can be performed by linear approximation by multi-regression expression or the like.

In this preferred embodiment, a very efficient design support system can be realized by using an objective function that is calculated and mathematically processed thus in the early stage of slider design, more particularly for the determination of a Pareto boundary as explained below.

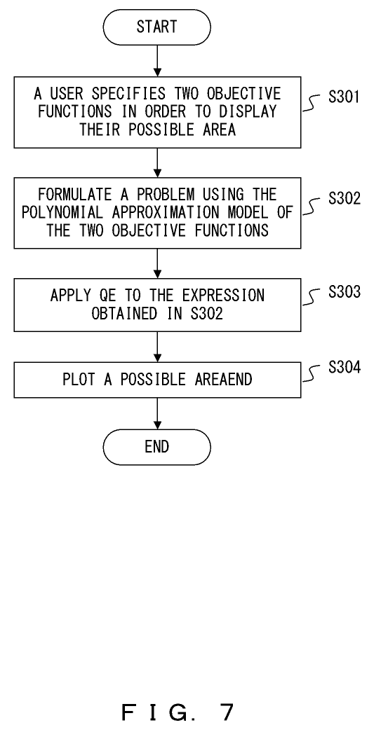

Next, FIG. 7 is an operational flowchart illustrating the processes of the objective function selection unit 103, the inter-objective function logical expression calculation unit 104 and the possible area display unit 105 which are illustrated in FIG. 5.

Firstly, a user selects two objective functions whose possible area is desired to display in the objective function selection unit 103 illustrated in FIG. 5 (block S301 in FIG. 7). Here the objective functions are assumed to be f1 and f2. In this preferred embodiment, three objective functions can be also specified instead of two objective functions.

Then, the inter-objective function logical expression calculation unit 104 illustrated in FIG. 5 formulized the two (or three) objective functions selected by the objective function selection unit 103 using each objective function polynomial calculated by the objective function polynomial approximation unit 102 and the constraints of each parameter value of the input parameter sample set 110 (block S302 in FIG. 7). Thus, for example, a formula exemplified below can be obtained. Although in this formula the number of parameters is left unreduced to be 15, the number may be reduced.

y1=f1(x1, . . . ,x15), y2=f2(x1, . . . , x15)F≅∃x₁∃x₂ . . . ∃x₁₅; 0≦x₁≦1 and 0≦x₂≦1 and . . . and 0≦x₁₅≦1 and y₁=f₁(x₁, . . . , x₁₅) and y₂=f₂(x₁, . . . ,x₁₅) (Input parameters x1, . . . , x15 vary in the range of 0≦x_{—}i≦1.) (4)

Then, the inter-objective function logical expression calculation unit 104 applies a QE method to the value F of Expression (4) to calculate a logical expression among the two or three objective functions selected by the objective function selection unit 103 (block S303 in FIG. 7). As a result, as exemplified below, input parameters x1 through x15 are cancelled and a logical expression about two objective functions y1 and y2 is outputted. In the case of three objective functions, a logical expression about three objective functions y1, y2 and y3 is outputted.

y2<y1+1 and y2<2 and y2<2*y1−3 (5)

Although the details of the QE method are omitted in the present specification, processing in the QE method is disclosed in a publicly known reference by the inventor of the present invention, “Actual Calculation Algebraic/Geometric Introduction: Summary of CAD and QE”, HirokazuAnai and Kazuhiro Yokoyama, Mathematic Seminar, No. 11, pp. 64-70, 2007. This preferred embodiment also adopts the processing.

Then, the possible area display unit 105 illustrated in FIG. 5 displays the possible area of the two objective functions on a computer display according to the logical expression between arbitrary two objective functions, calculated by the inter-objective function logical expression calculation unit 104 (block S304 in FIG. 7).

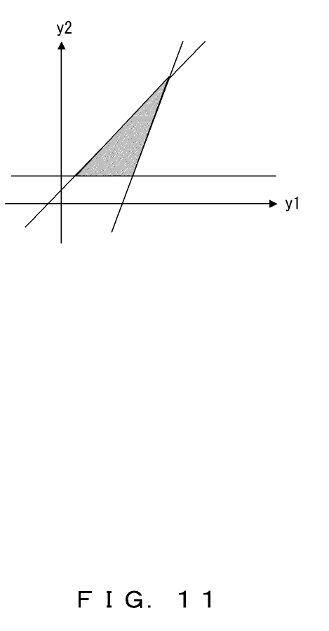

More specifically, the possible area display unit 105 continues to paint over points in which the logical expression about the two objective functions y1 and y2 that is exemplified in Expression (5) calculated by the inter-objective function logical expression calculation unit 104 holds true while sweeping each point on a two-dimensional plotting plane about the two objective functions y1 and y2. As a result, a possible area can be displayed, for example, in a form as illustrated as the painted area in FIG. 11.

In the case of three objective functions, the possible area display unit 105 may display them three-dimensionally. Another specific example of the above-described possible area display is explained below.

It is assumed that as exemplified below, the approximation polynomial of two objective functions is composed of three input parameters x1, x2 and x3.

y1=f1(x1, x2, x3)=x1−2*x2+3*x3+6

y2=f2(x1, x2, x3)=2*x1+3*x2−x3+5 (6)

The result of formulating Expression (6) is as follows.

F:=∃x₁∃x₂∃x₃; 0≦x₁≦1 and 0≦x₂≦1 and 0≦x₃≦1 and y₁=x₁−2x₂+3x₃+6 and y₂=2x₁+3x₂−x₃+5 (7)

The result of further applying a QE method to Expression (7) is as follows.

(3*y1+2*y2−35>=0 and 3*y1+2*y2−42>=0 and y1+3*y2−28>=0 and y1+*y2−352>=0)

or (3*y1+2*y2−28>=0 and 3*y1+2*y2−35>=0 and 2*y1−y2−7>=0 and 2*y1−y2>=0)

or (2*y1−y2−7>=0 and 2*y1−y2−14>=0 and y1+3*y2−21>=0 and y1+3*y2−28>=0) (8)

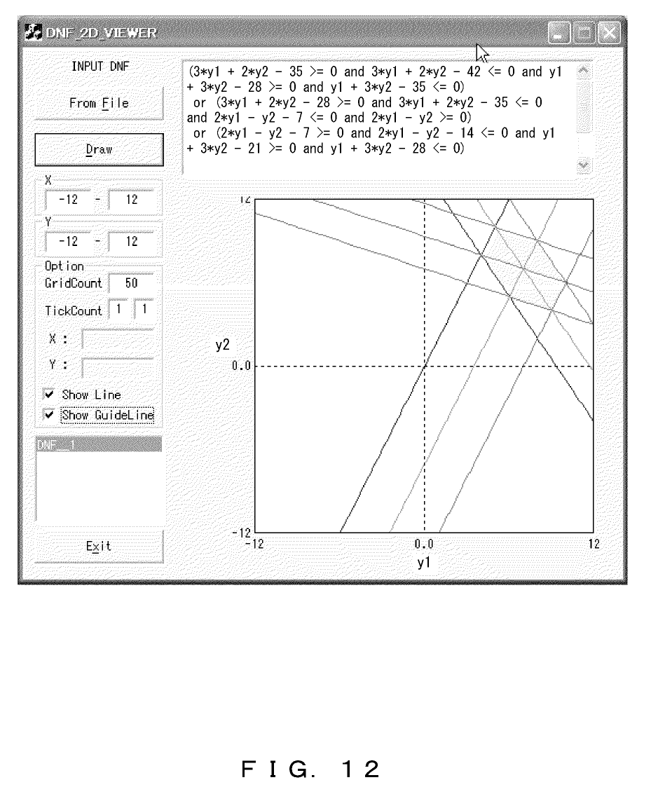

The result of plotting a possible area according to the logical expression of Expression (8) may be, for example, as illustrated in FIG. 12. In FIG. 12, an oblique straight line indicates each logical boundary of the logical expression of Expression (8) and a painted area indicates the possible area of two objective functions.

As clear from display in FIG. 12, in the painted possible area, the Pareto boundary of the two objective functions can be easily recognized intuitively as the boundary of the bottom edge near the coordinate origin and an optimization limit area can be recognized. In the case of three objective functions, although the Pareto boundary becomes a curved surface (Pareto surface), the surface can also be displayed three-dimensionally.

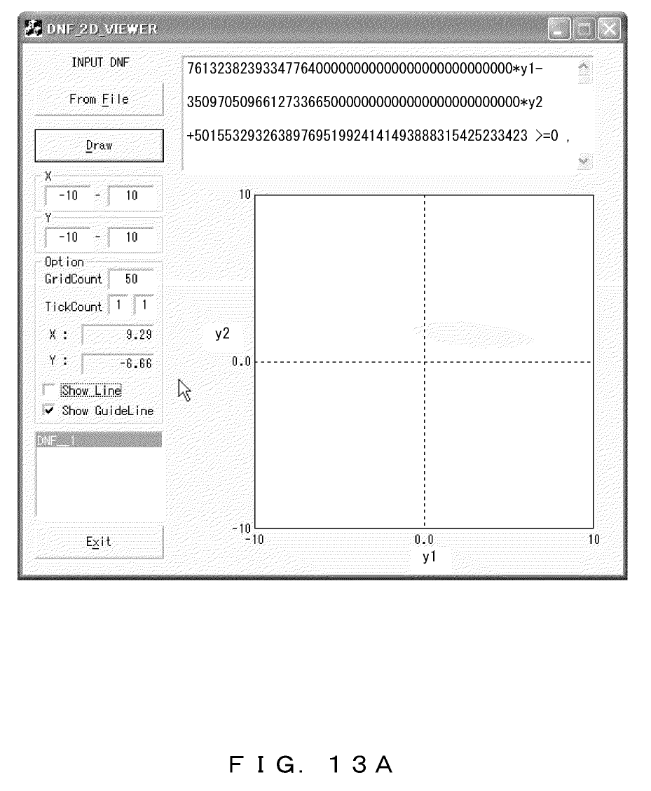

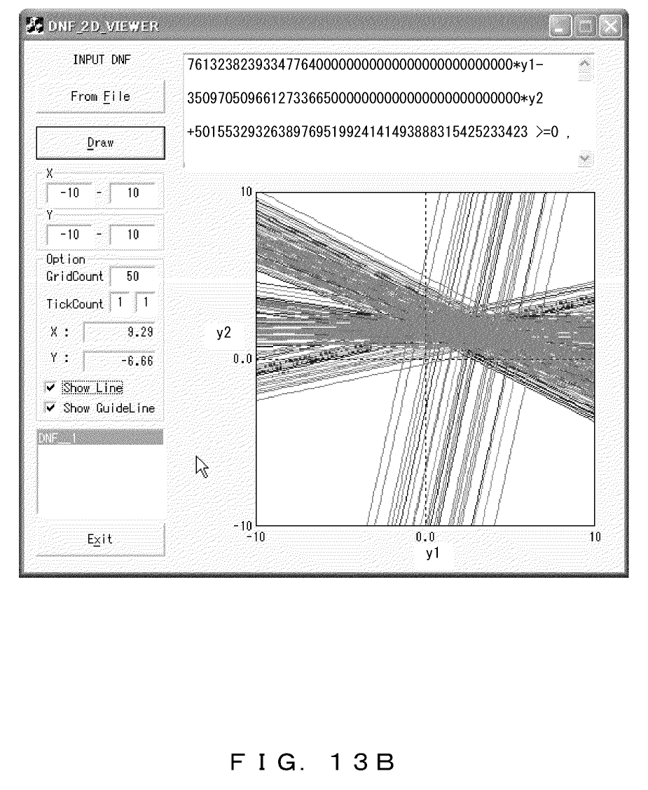

FIG. 13A is a possible area display example obtained using the input parameter sample set 110 corresponding to an actual slider shape. FIG. 13B is a possible area display example in the case where the boundary of a logical expression is also displayed. In this example, assuming that the amount of slider flying height in low altitude (0 m) and a difference in the amount of slider flying height between in low altitude (0 m) and in high altitude (4200 m) are the first objective function f1 and the second objective function f2, respectively, their relationship y1 and y2 is expressed in a graph.

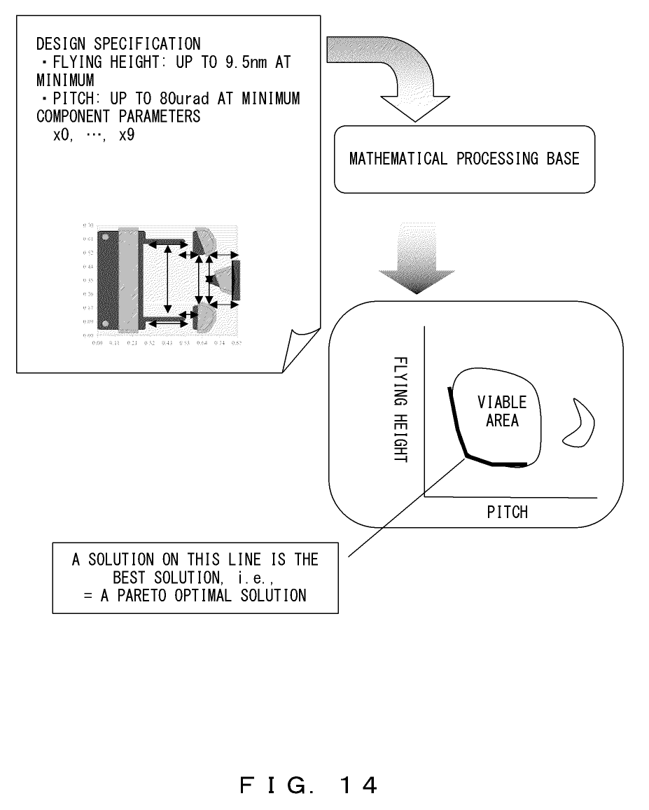

In the above-explained process of this preferred embodiment, as illustrated in FIG. 14, a multi-objective optimization process can be performed on the basis of a mathematical process by polynomial approximation and a Pareto optional solution can also be mathematically displayed. Therefore, a Pareto optional solution can be easily obtained.

A Pareto optimal solution may be easily emphasized by emphatically displaying a display point which appears on the utmost left side on each scanning line when painting over points in which the logical expression about the two objective functions calculated by the inter-objective function logical expression calculation unit 104 (Expression (5), (8) or the like) holds true while sweeping each point on a two-dimensional plotting plane about arbitrary two objective functions. This is a very advantageous feature when compared with the prior art in which it is difficult even to emphatically display a Pareto optimal solution since the Pareto optimal solution is plotted and displayed.

In the above-described possible area display process, a user can efficiently specify both a possible area and a Pareto boundary for each objective function while sequentially specifying two objective functions in the objective function selection unit 103 illustrated in FIG. 5.

Next, the operations of the function value calculate ion unit 106 and the inverse mapper 107 are explained.

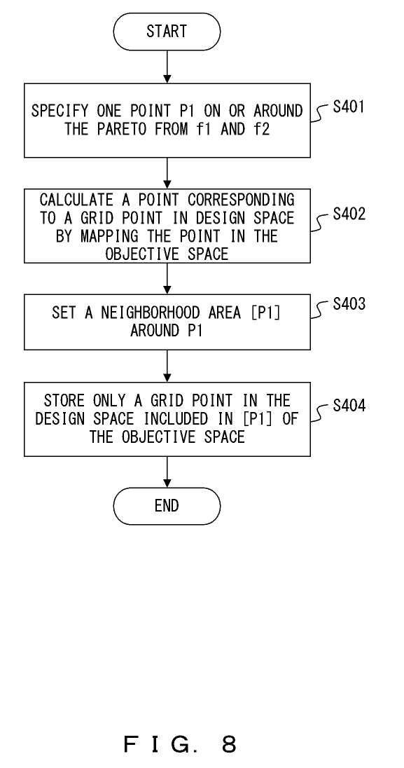

FIG. 8 is an operational flowchart illustrating the processes of the function value calculation unit 106 and the inverse mapper 107 which are illustrated in FIG. 5.

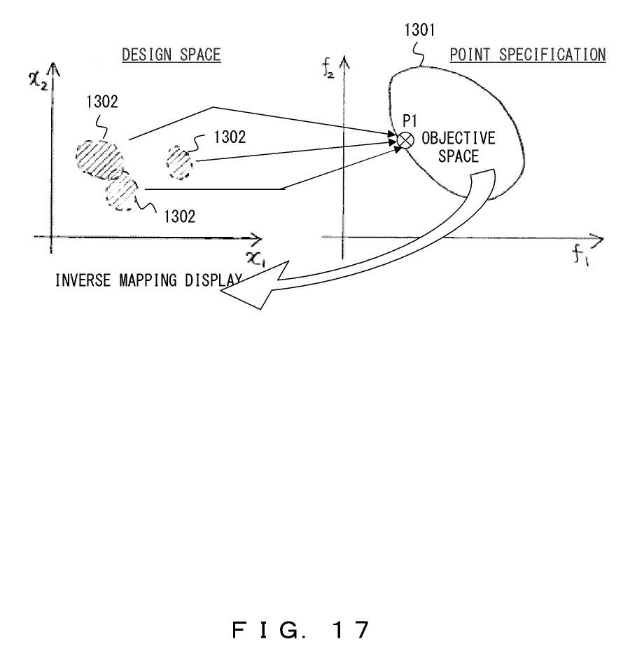

Firstly, a user specifies one point P1 on the Pareto boundary of the possible area of objective functions f1 and f2 displayed in such a way as to display the possible area as 1301 in FIG. 17, in the possible area display unit 105 (block S401 in FIG. 8).

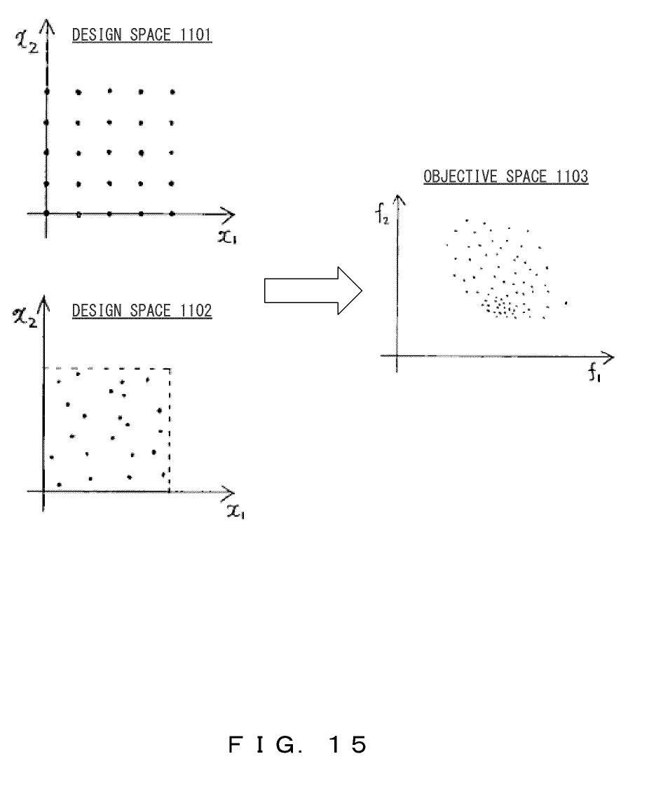

Then, the function value calculation unit 106 maps each grid point obtained by cutting the coordinate (design space) 1101 or 1102 illustrated in FIG. 15 in mesh which is composed of design parameters into the objective space 1103 illustrated in FIG. 15, and the function value calculation unit 106 calculates a corresponding point related to each grid point, using the approximation polynomial of two or three specified objective functions calculated by the objective function polynomial approximation unit 102 illustrated in FIG. 5 (block S402 in FIG. 8). In this case, if the approximation polynomial of objective functions is expressed by, for example, ten design parameters due to the above parameter reduction, the grid point is on a ten-dimensional coordinate. If it is assumed that each design parameter takes, for example, a value between 0 and 1 as indicated by Expression (4) or the like, in the function value calculation unit 106, for example, each parameter may be divided into three groups between 0 and 1 and each grid point may be set in such a way as to take one of three values of ⅙, ½ and ⅚. As a result, for example, if the number of degrees is ten as described above, the number of grid points is 3¹⁰(=59049). In the function value calculation unit 106, calculation using the approximation polynomial of two or three objective functions expressed in Expression (4) or the like is applied to each of these grid points and each mapped point in two-dimensional or three-dimensional objective space 1103 as illustrated in FIG. 15 is calculated.

How to cut in mesh in design space can also be at random as indicated by design space 1102, regular triangle, regular hexagon, circle or the like, besides square as indicated by design space 1101. The number of grid points may be specified by a user as described above.

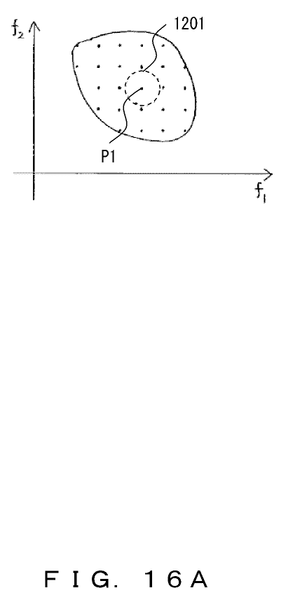

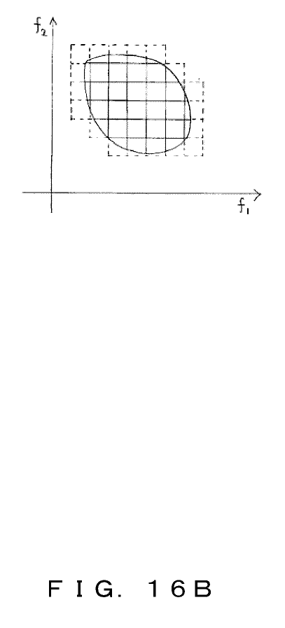

Then, the inverse mapper 107 sets a neighborhood area around a specified point P1 in the objective space specified in block S401 of FIG. 8 (block S403 in FIG. 8). This area is described as [P1]. As illustrated in FIG. 16A, when determining the neighborhood area 1201 of the specified point P1, it is preferable that the shape of the neighborhood area is square as illustrated in FIG. 16B. However, it can also be regular triangle, regular hexagon, circle or the like.

Then, the inverse mapper 107 stores only a grid point in design space corresponding to a mapped point included in the area [P1] specified in block S403 of FIG. 8 in memory or the like, which is not especially illustrated (block S404 in FIG. in 8).

As a result, of all the grid points of 3¹⁰(=59049), for example, approximately several tens of grid points are stored as grid points in design space included in the specified area [P1].

In this case, as illustrated in FIG. 17, the above several tens of grid points maybe ten-dimensional design parameter sets corresponding to point P1 being almost an optimal solution near the Pareto boundary in a possible area 1301. The design parameter sets may be classified into several groups indicated as 1302. This indicates that there can be a plurality of design parameter sets, that is, design shapes that can satisfy a certain objective function group.

Then, the inverse mapping classification/calculation unit 108 in FIG. 5 automatically calculates the above group.

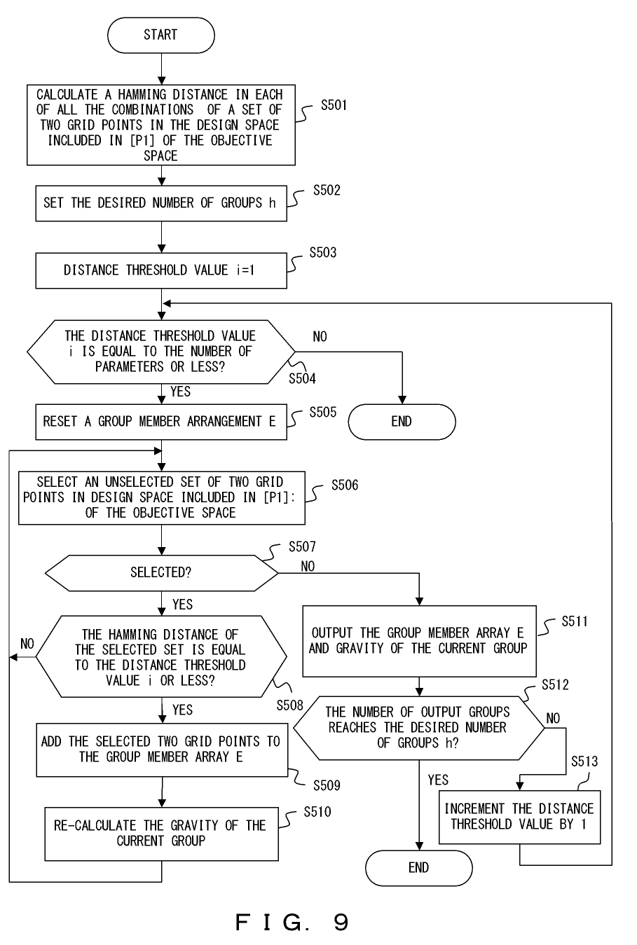

FIG. 9 is an operational flowchart illustrating the process of the inverse mapping classification/calculation unit 108.

Firstly, the inverse mapping classification/calculation unit 108 calculates in advance each Hamming distance of all the combinations composed of two grid points, of the above-described several ten sets of grid points in design space included in the specified area [P1] of an objective space, calculated by the function value calculation unit 106 and the inverse mapper 107 in FIG. 5 illustrated in the operational flowchart in FIG. 8 (block S501). In this case, the Hamming distance between two grid points is the number of different parameter values in the case where the positions of one parameter line composed of ten grid points and the other parameter line composed of ten grid points are matched and the parameters are compared. As a distance between two grid points, a Euclid distance or the like may be also adopted instead of the Hamming distance.

Then, the inverse mapping classification/calculation unit 108 enables a user to input the number of candidates (number of groups) of a slider shape or the like to display as the desired number of groups h (block S502).

Then, after setting a distance threshold value i to 1 in block S503, in block S504 the inverse mapping classification/calculation unit 108 performs a series of processes in blocks S505 through S510 until it is determined in block S504 that the distance threshold value i becomes equal to the number of parameters (if the dimension of a grid point is ten, the number of parameters is ten) while incrementing the distance threshold value i by one in block S513.

In the series of processes, firstly the inverse mapping classification/calculation unit 108 resets group member arrangement E (block S505).

Then, the inverse mapping classification/calculation unit 108 selects a set in which two grid points in design space included in the specified area [P1]in objective space are not selected yet (block S506→yes in block S508).

Then, the inverse mapping classification/calculation unit 108 adds the identification information of the selected two grid points whose Hamming distance (calculated in block S501) is equal to or less than the distance threshold value i (“yes” in block S508) to the group member arrangement E as the member of the current group (block S509) and also re-calculates the gravity of the current group (block S510).

After this process or if the determination in block S508 is no, the process returns to block S506. In block S506, the inverse mapping classification/calculation unit 108 further selects an unselected set and performs the same process.

After selecting all the sets (“no” in block S507), the inverse mapping classification/calculation unit 108 outputs both the group member arrangement E and gravity of the current group to the representative shape display unit 109 (block S511).

Then, the inverse mapping classification/calculation unit 108 determines whether the number of output groups reaches the desired number of groups h (block S512). If the determination is no, in block S513 the inverse mapping classification/calculation unit 108 increments the distance threshold value i by one and the process returns to block S504. In block S504 the inverse mapping classification/calculation unit 108 continues to classify two grid points whose Hamming distance is the second farthest.

When the number of output groups reaches the desired number of groups h and the determination in block S512 becomes yes or when the distance threshold value i exceeds the number of parameters (for example, 10) and the determination in block S504 becomes no, the inverse mapping classification/calculation unit 108 finishes the classification process.

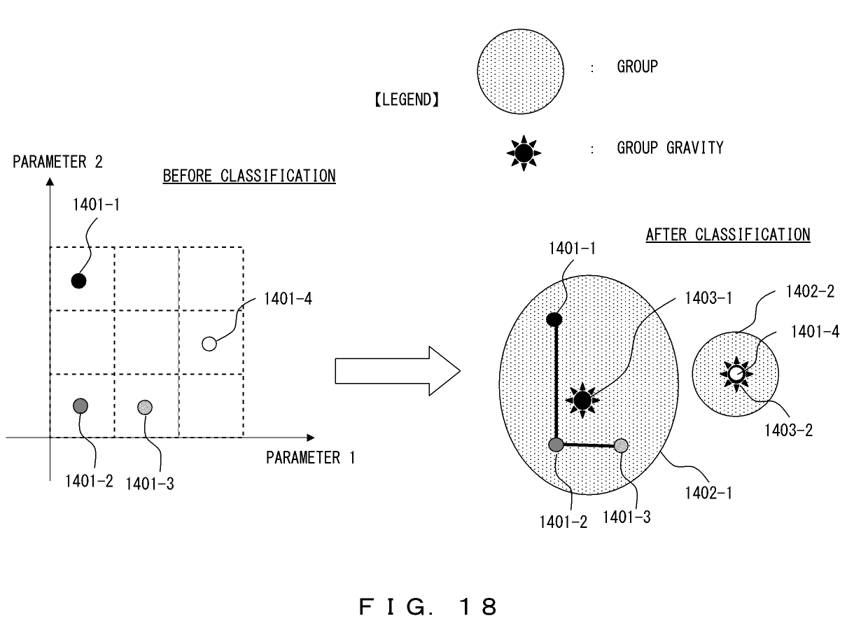

FIG. 18 explains the operating principle of the above-described inverse mapping classification process of the inverse mapping classification/calculation unit 108 in a simple view.

A case where as to parameters 1 and 2 (actually ten dimensions of parameters 1 through 10), four grid points 1401-1 through 1401-4 are distributed in design space included in the specified area [P1]in objective space before classification is considered.

Since each of the Hamming distance between grid points 1401-1 and 1401-2 and the Hamming distance between grid points 1401-2 and 1401-3 becomes 1, after these grid points are classified into one group 1402-1 and its gravity becomes a grid point 1403. However, since the Hamming distance between the grid point 1401-4 and any other grid point does not become 1, the grid point 1401-4 is individually classified into one group 1302-2 and its gravity also becomes the same grad point 1401-4.

Then, the representative shape display unit 109 in FIG. 5 calculates each design parameter set representing each group classified by the inverse mapping classification/calculation unit 108 as described above and displays each representative shape corresponding to each design parameter set through a CAD software.

More specifically, the representative shape display unit 109 displays a slider shape corresponding to each of ten design parameter sets constituting a grid point a grid point nearest the gravity of respective grid points included in the group member arrangement E on a display device, which is not especially illustrated, by selecting the grid point on the basis of the group member arrangement E and gravity of each group, outputted by the reverse classification/calculation unit 108 and inputting the design parameter sets to a CAD software, which is not especially illustrated.

Alternatively, an objective function can be also re-calculated on the basis of a design parameter set constituting gravity and if the objective function value is small, a slider shape corresponding to a design parameter set constituting the gravity can be also displayed.

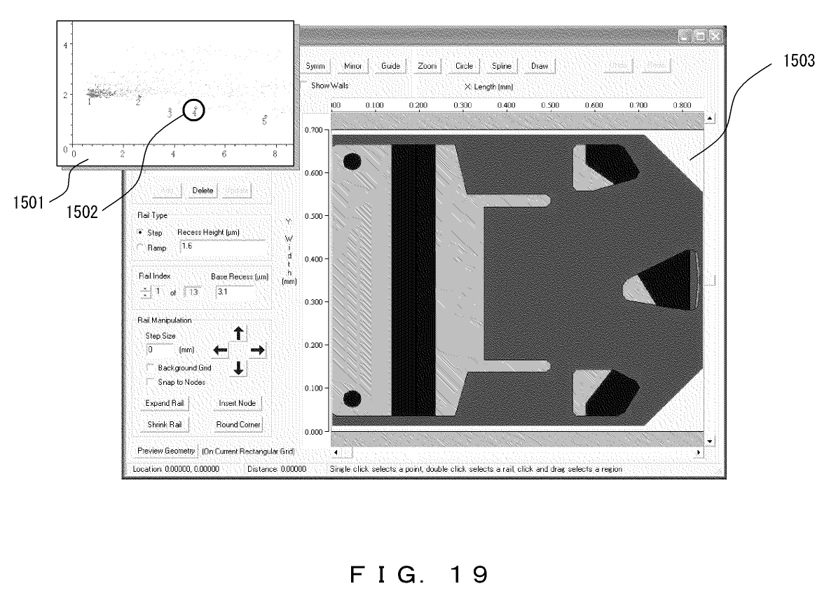

FIGS. 19 through 23 illustrate the specific operation examples of this preferred embodiment.

Element 1501 in FIG. 19 is a possible area example of the slider shape of a hard disk, displayed by the possible area display unit 105 in FIG. 5. The horizontal and vertical axes are the first objective function f1 indicating the amount of slider fly, for example, in low altitude (0 m) and the second objective function f2 indicating a difference in the amount of slider flying height between in low altitude (0 m) and in high altitude (4200 m), respectively. Reference numerals 1 through 5 in this display are optimal solution candidates on the Pareto boundary.

If a user specifies, for example, that an optimal solution indicated by 4 in the display 1501 as 1502 in FIG. 19, a slider shape determined by a design parameter set corresponding to the solution may be displayed as 1503 in FIG. 19.

Next, inverse mapping calculation where the neighborhood area of the optimal solution indicated by 4 in the display 1501 of FIG. 19 is specified as the above-described specified area [P1] will be discussed.

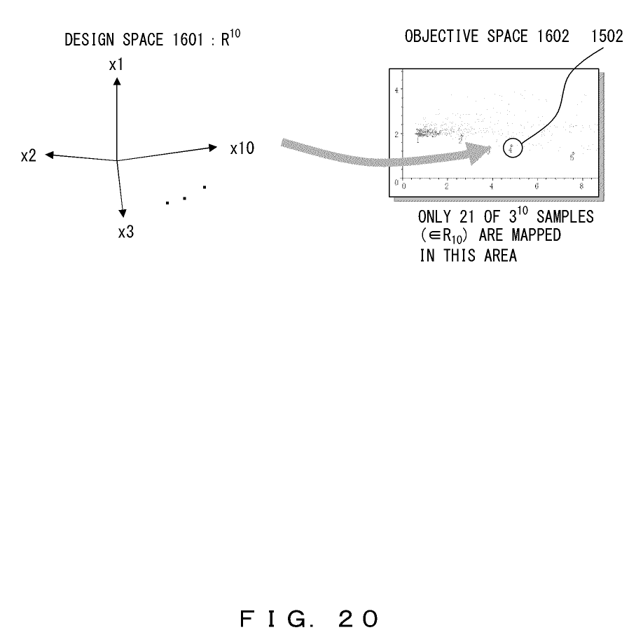

The function value calculation unit 106 in FIG. 5 may obtain 3¹⁰(=59049) grid points in ten-dimensional design space by dividing each design parameter value xi (1≦i≦10)in ten-dimensional design space 1601 illustrated in FIG. 20 by three in such a way to take three values of {⅙, ½ and ⅚} between 0 and 1. The function value calculation unit 106 applies calculation using the approximation polynomial of two objective functions f1 and f2 indicated in Expression (4) or the like to each of these grid points and calculates each mapped point in the objective space 1602.

Then, the inverse mapper 107 in FIG. 5 may calculate 21 grid points as grid points in the design space 1601 to be mapped in the specified area 1502 in the objective space 1602 of FIG. 20, of the above 3¹⁰ mapped points.

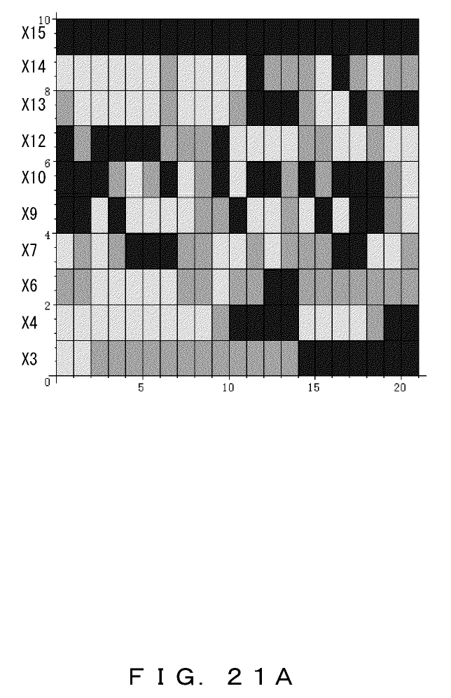

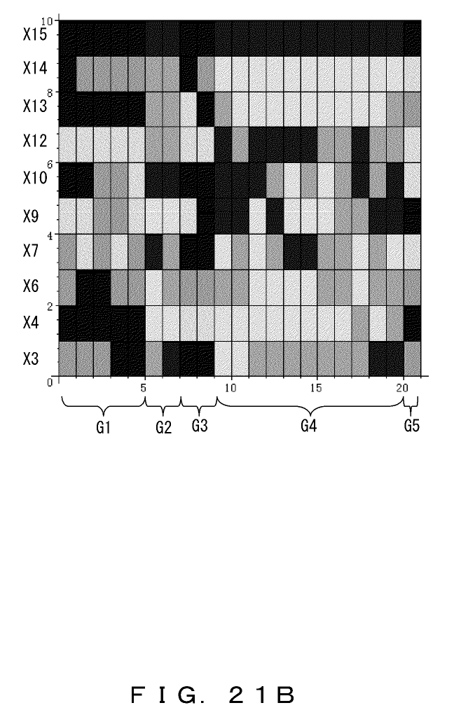

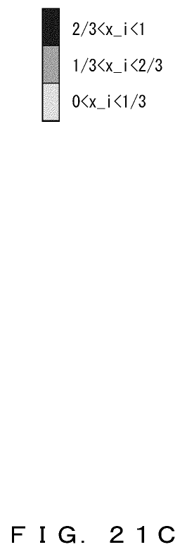

FIG. 21A illustrates the result. Reference numerals in the horizontal direction of FIG. 21A indicates the number of samples of 1 through 21 and X3, X4, X6, X7, X9, X10, X12, X13, X14 and X15 in the vertical direction indicates ten design parameters determined by the reduction process. Thus, one vertical line in FIG. 21A indicates ten design parameter sets of one grid point and 21 horizontal lines indicate 21 samples. The gradation of each line indicates the earlier-described respective three-divided values illustrated in FIG. 21C.

Then, the inverse mapping classification/calculation unit 108 applies the classification process, indicated by the operational flowchart in FIG. 19, to the 21 design parameter sets obtained by the inverse mapper 107 in FIG. 5.

As a result, the horizontal lines of the 21 design parameter sets illustrated in FIG. 21A are re-arranged and classified into five groups of G1 through G5 as illustrated in FIG. 21B.

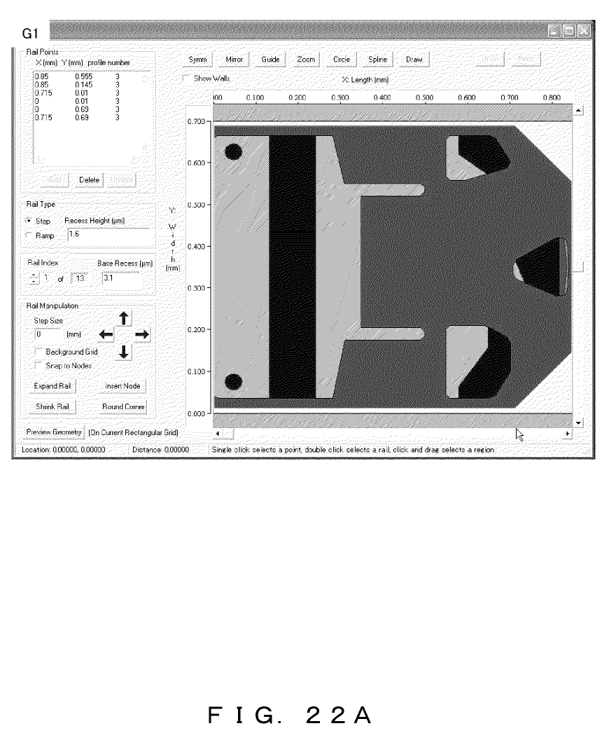

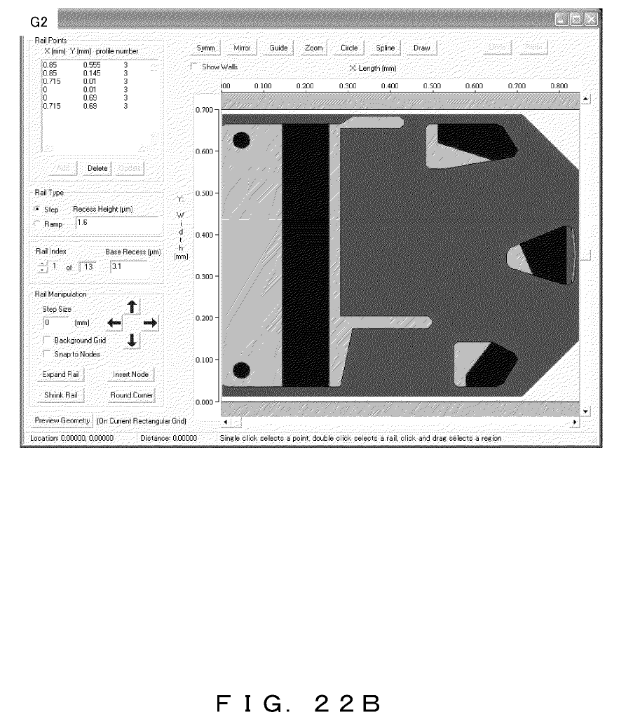

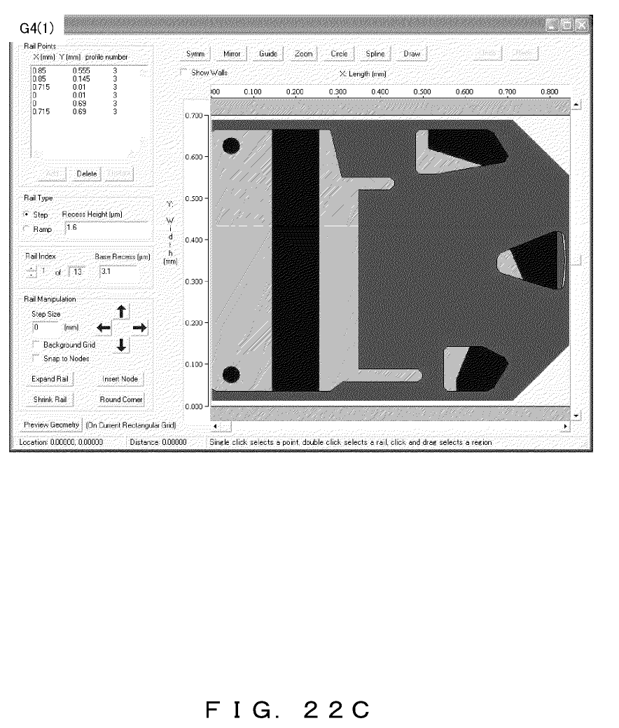

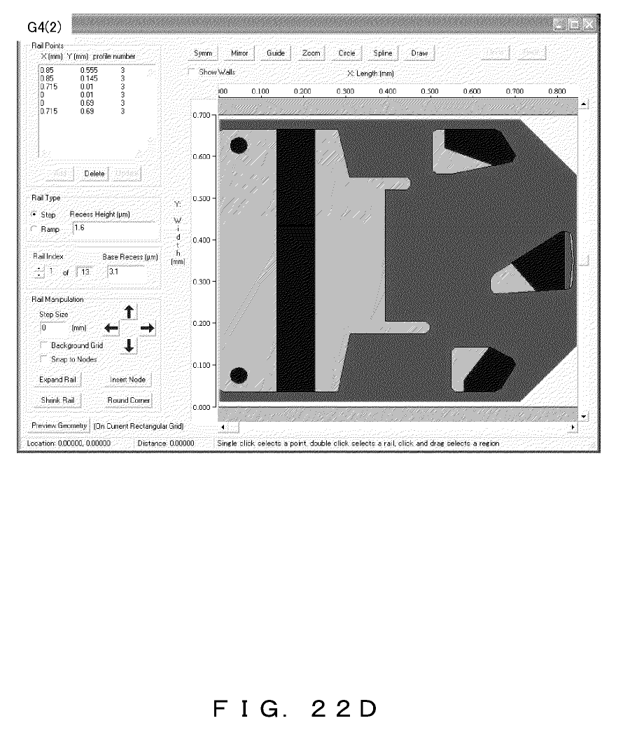

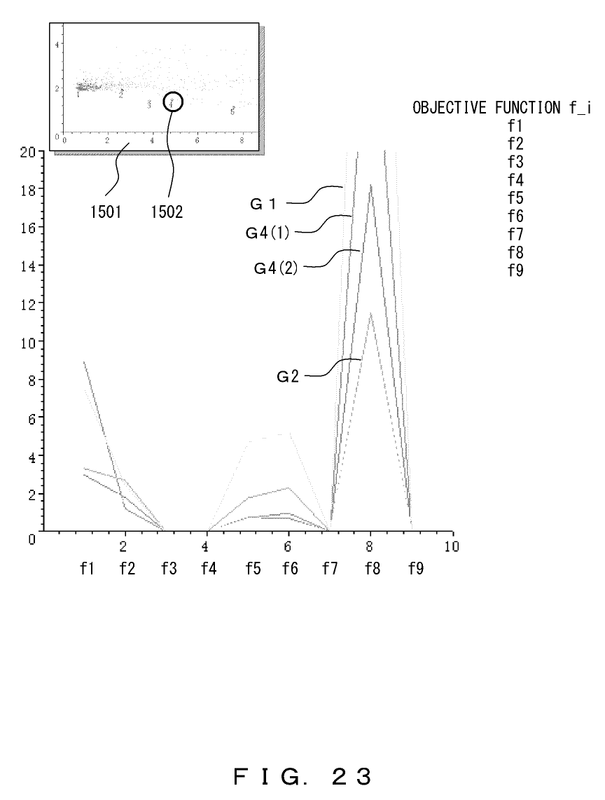

FIGS. 22A through 22D illustrate representative slider shapes displayed by the representative shape display unit 109 in FIG. 5. FIGS. 22A, 22B, 22C and 22D are a slider shape representing a group G1 in FIG. 21B, a slider shape representing a group G2 in FIG. 21B, the first slider shape representing a group G4 in FIG. 21B and the second slider shape representing a group G4 in FIG. 21B, respectively. Objective functions corresponding to a design parameter set representing each group illustrated in FIGS. 22A through 22D may indicate, for example, distribution illustrated in FIG. 23. G1, G2, G4(1) and G4 (2) in FIG. 23 correspond to FIGS. 22A through 22D, respectively.

In this way, a user can receive not only the slider shape of a design parameter set corresponding to the optimal solution 1502 illustrated in FIG. 19, but also a plurality of slider shape candidates illustrated in FIGS. 22A through 22D which can be automatically estimated from the neighborhood area of the optimal solution 1502 in a possible area. The user may get the hint of a base shape for further optimization.

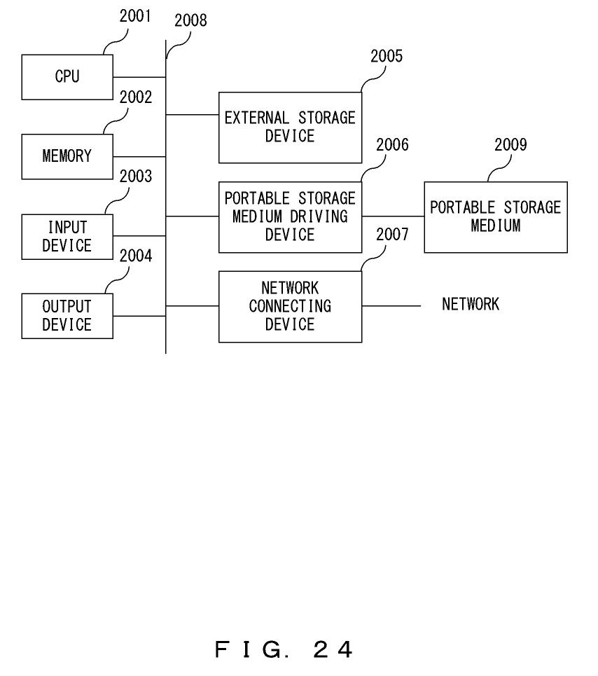

FIG. 24 illustrates an example hardware configuration of a computer capable of realizing the above-described system.

A computer illustrated in FIG. 24 includes a CPU 2001, memory 2002, an input device 2003, an output device 2004, an external storage device 2005, a portable storage medium driving device 2006 in which a portable storage medium 2009 is inserted and a network connecting device 2007, which are connected to each other by a bus 2008. The configuration illustrated in FIG. 24 is one example of a computer capable of realizing the above-described system and such a computer is not limited to this configuration.

The CPU 2001 controls the entire computer. The memory 2002 is RAM or the like for temporarily storing a program or data stored in the external storage device 2005 (or portable storage medium 2009) when executing the program, updating the data and the like. The CPU 2001 controls the entire computer by reading the program into the memory 2002 and executing it.

The input device 2003 includes, for example, a keyboard, a mouse and the like and their interface control devices. The input device 2003 detects the input operation of the keyboard, the mouse and the like by a user and notifies the CPU 2001 of the detection result.

The output device 2004 includes a display device, a printing device and the like and their interface control devices. The output device 2004 outputs data transmitted under the control of the CPU 2001 to the display device and the printing device.

The external storage device 2005 is for example, a hard disk storage device and is mainly used to store various data and programs.

The portable storage medium driving device 2006 accommodates a portable storage medium 2009, such as an optical disk, SDRAM, compact flash and the like and plays the auxiliary role of the external storage device 2005.

The network connecting device 2007 is used to connect a communication line, such as LAN (local network area) or WAN (wide area network).

The system according to this preferred embodiment is realized by the CPU 2001 executing a programmounting functional blocks illustrated in FIG. 5. The program can be recorded, for example, on the external storage device 2005 or the portable storage medium 2009 and be distributed. Alternatively, it can be obtained from a network by the network connecting device 2007.

Although in the above-described preferred embodiment, the present invention is implemented as a design support device for supporting the slider design of a hard disk, the present invention is not limited to this, and may be applied to various devices for supporting design while performing multi-objective optimization.

As described above, by using samples calculated in optimization or by analyzing the group of parameter values to be mapped near an optimal solution (point on a Pareto) in addition to a new sample, using an approximation expression, an efficient shape different from an optimal solution may be provided and a hint for working out a new base shape may be given to a designer.

Furthermore, an objective function can be approximated from some of the design parameters for the slider shape and the like of a hard disk by a mathematical expression, such as a polynomial or the like and the expression can be calculated using a mathematical processing method. Thus, since input parameters can be handled as-is, a logical relationship between objective functions and an input/output relationship can be easily obtained.

Although in the above-described preferred embodiments, objective functions are mathematically processed, a possible area in objective space is displayed and the inverse mapping of design space corresponding to it, a possible area in a comparison-target objective space and the like are displayed, a possible area in objective space may be also displayed according to another method for calculating an objective function on the basis of design parameters, and the inverse mapping of design space corresponding to the possible area and a representative shape and the like may be also displayed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should b understood that the various changes, substitutions, and alterations could be made hereto without departing from the spirit and scope of the invention.

1. A device for classifying/displaying design shapes whose characteristics are similar but whose shapes are different in a design support apparatus for supporting determination of an optimal design parameter set by inputting a plurality of design parameter sets, calculating a plurality of objective functions on the basis of a prescribed calculation, and applying a multi-objective optimization process to the plurality of objective functions, said device comprising:
an objective space display unit to display an area which a value of arbitrarily-selected objective functions of the plurality of objective functions can take on the basis of a plurality of objective function values each of which is calculated for the plurality of the design parameter sample sets, the area being displayed as a possible area in objective space corresponding to the arbitrarily-selected objective functions;
an objective space-corresponding design space calculation unit to calculate the design parameter set in design space corresponding to a neighborhood area of a position in the objective space based on the position specified by a user in the possible area in the objective space corresponding to the arbitrarily-selected objective functions, the possible area being displayed by the objective space display unit; and
a representative shape display unit to calculate and display a representative design shape corresponding to the design parameter set calculated by the objective space-corresponding design space calculation unit.

2. A device for classifying/displaying design shapes whose characteristics are similar but whose shapes are different in a design support apparatus for supporting determination of an optimal design parameter set by inputting a plurality of design parameter sets, calculating a plurality of objective functions on the basis of a prescribed calculation, and applying a multi-objective optimization process to the plurality of objective functions, said device comprising:
a sample set objective function calculation unit to calculate the plurality of objective function sets for a prescribed number of the design parameter sample sets;
an objective function approximation unit to mathematically approximate the plurality of objective functions on the basis of the prescribed number of sets of the design parameter sample sets and a plurality of objective function sets calculated in relation to the prescribed number of sets of the design parameter sample sets;
an inter-objective function logical expression calculation unit to calculate a logical expression indicating a logical relationship among arbitrarily-selected two or more objective functions of the plurality of mathematically approximated objective functions as an inter-objective function logical expression;
an objective space display unit to display an area which the two or more objective functions can take, as a possible area in objective space corresponding to the two or more objective functions;
an objective space-corresponding design space calculation unit to calculate the design parameter set in design space corresponding to a neighborhood area of a position in the objective space based on the position specified by a user in the possible area of the objective space corresponding to the two or more objective functions displayed by the objective space display unit; and
a representative shape display unit to calculate and display a representative design shape corresponding to a design parameter set calculated by the objective space-corresponding design space calculation unit.

3. The device of claim 1, further comprising
a design parameter classification unit to classify the design parameter sets calculated by the objective space-corresponding design space calculation unit into a plurality of groups, and wherein
the representative shape display unit calculates and displays a representative design shape corresponding to a design parameter set representing each group classified by the design parameter classification unit.

4. The device of claim 1, wherein
said objective space-corresponding design space calculation unit comprises:
a function value calculation unit to calculate each mapped point in the objective space corresponding to each of the design parameter sets constituting a plurality of grid points for dividing the design space; and
an inverse mapper to calculate the design parameter set constituting the grid point corresponding to a mapped point, included in a neighborhood area of a position in the objective space based on the position specified by the user, of the mapped points, as the design parameter set in the design space corresponding to the neighborhood area of the position in the objective space based on the position specified by the user.

5. The device of claim 1, wherein
said design parameters are parameters for determining a shape of a slider unit of a hard disk magnetic storage device.

6. The device of claim 2, further comprising
a design parameter classification unit to classify the design parameter sets calculated by the objective space-corresponding design space calculation unit into a plurality of groups, and wherein
the representative shape display unit calculates and displays a representative design shape corresponding to a design parameter set representing each group classified by the design parameter classification unit.

7. The device of claim 2, wherein
said objective space-corresponding design space calculation unit comprises:
a function value calculation unit to calculate each mapped point in the objective space corresponding to each of the design parameter sets constituting a plurality of grid points for dividing the design space; and
an inverse mapper to calculate the design parameter set constituting the grid point corresponding to a mapped point, included in a neighborhood area of a position in the objective space based on the position specified by the user, of the mapped points, as the design parameter set in the design space corresponding to the neighborhood area of the position in the objective space based on the position specified by the user.

8. The device of claim 2, wherein
said design parameters are parameters for determining a shape of a slider unit of a hard disk magnetic storage device.

9. A storage medium on which is recorded a program for enabling a computer for supporting determination of an optimal design parameter set by inputting a plurality of design parameter sets, calculating a plurality of objective functions on the basis of a prescribed calculation and applying a multi-objective optimization process to the plurality of objective functions, said program enables the computer to perform a method, the method comprising:
displaying an area which a value of arbitrarily-selected objective functions of the plurality of objective functions can take on the basis of a plurality of objective function values each of which is calculated for the plurality of the design parameter sample sets, the area being displayed as a possible area in objective space corresponding to the arbitrarily-selected objective functions;
calculating the design parameter set in design space corresponding to a neighborhood area of a position in the objective space based on the position specified by a user in the possible area in the objective space corresponding to the arbitrarily-selected objective function displayed with the act of displaying an area; and
calculating and displaying a representative design shape corresponding to the design parameter set calculated with the act of calculating the design parameter set.

10. The storage medium according to claim 9, wherein
said program further enables the computer to perform:
classifying the design parameter sets calculated by the act of calculating the design parameter set, and wherein
in the act of calculating and displaying a representative design shape, a representative design shape corresponding to a design parameter set representing each group classified by the act of classifying the design parameter sets is calculated and displayed.

11. The storage medium according to claim 9, wherein
the act of calculating the design parameter set in design space comprises:
calculating each mapped point in the objective space corresponding to each of the design parameter sets constituting a plurality of grid points for dividing the design space; and
calculating the design parameter set constituting the grid point corresponding to a mapped point, included in a neighborhood area of a position in the objective space based on the position specified by the user, of the mapped points, as the design parameter set in the design space corresponding to the neighborhood area of the position in the objective space based on the position specified by the user.

12. The storage medium according to claim 9, wherein
said design parameters are parameters for determining a shape of a slider unit of a hard disk magnetic storage device.
